(19) United States
(12) Patent Application Publication
(10) Pub. No.: US 2009/0244611 A1
(43) Pub. Date: Oct. 1, 2009

(54) Printer, Printer System and Printer Management Server

(75) Inventor: Koji TANAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/406,328

(22) Filed: Mar. 18, 2009

(30) Foreign Application Priority Data
Mar. 26, 2008 (JP) 2008-080337

(51) Int. Cl. G06F 3/12

(52) U.S. Cl. 358/1.15

(57) ABSTRACT

A printer includes a storing section configured to store prior expansion related information used for determination of whether the prior expansion process is to be executed, a self-based updating section configured to, on the basis of an event arising in the printer which makes it necessary for the printer to update the prior expansion related information, update the prior expansion related information stored in the storing section, and a reception-based updating section configured to, subsequent to updating of the prior expansion related information in another printer or other printers of the same type as the printer, receive the updated prior expansion related information, and update the prior expansion related information stored in the storing section in accordance with the received prior expansion related information.

### BACKGROUND

1. Technical Field

The present invention relates to printers or the like for performing a prior expansion process from intermediate code and, more particularly, a printer or the like capable of reducing the probability of occurrence of overrun errors to a greater degree than ever before by utilizing a network.

2. Field of Invention

In typical printers, upon receipt of printing data described in a printer description language, the printing data is once converted into a drawing code, which is termed an intermediate code, and then, is stored. Subsequently, the intermediate code is expanded into image data for each pixel, and then, in accordance with the image data, printing processes are performed in a printing executing section.

Further, in a printer, such as a laser printer, in which printing processes are performed on a page-by-page basis in a printing executing section, a printing procedure is such that, in conjunction with commencement of operations in the printing executing section, image data of one page, which is generated and stored in advance, is read out, and then/subsequent processes are performed in synchronization with operations performed by the printing executing section. However, in such a printing procedure as described above, it is necessary to complete performing of a process of expanding the intermediate code into the image data prior to commencement of the processes performed in synchronization with operations performed by the printing executing section, and this necessity leads to increasing of a processing time spent from receipt of a request for printing until completion of the requested printing. Therefore, there are existing printing devices in which the process of expanding the intermediate code into image data is performed during a series of processes performed in synchronization with operations performed by the printing executing section. In such a case, just intermediate code of one page is required to be generated and stored in advance, and thus, it is possible to increase a throughput of the printing device.

In such a printing device as described above, since it takes a relatively long time for the printing device to perform the process of expanding the intermediate code into image data, a certain image targeted for printing possibly causes a condition in which the process of expanding the intermediate code into image data cannot be completed in time for operations performed by the printing executing section. In order to reduce the probability of such an occurrence of overrun errors, in existing printing devices, a prior expansion process, in which, for each page targeted for printing, evaluations are performed for respective predetermined bounds, and on the basis of the evaluation results, regarding respective bounds for which a relatively long time needs to be spent in performing the process of expanding the intermediate code into image data, the processes of expanding the intermediate code into image data are performed in advance, has been performed. However, to achieve the primary object, it is not allowed to spend a long time in the evaluation performed on the basis of each bound, and as a result, the evaluation is not performed with high accuracy, so that, notwithstanding adoption of the prior expansion process, the condition where the overrun errors possibly occur still remains.

Therefore, in JP-A-2001-1576 and JP-A-2006-205403, a method, in which, in the case where, notwithstanding adoption of the prior expansion process, the overrun errors still occur, information used for the evaluation is updated so that the subsequent probability of occurrence of the overrun errors can be reduced, has been proposed.

By using such an existing technology as described above, in the case where the overrun errors occur in a printer, the accuracy of evaluation for the prior expansion process in the printer is enhanced, and as a result, it is possible to reduce the probability of occurrence of the overrun errors in the printer.

However, in other printers of the same type as the printer in which evaluation information regarding the prior expansion is improved, evaluation information currently used in the foregoing other printers is previous information which is not yet updated, and thus, when the foregoing other printers perform printing of an image similar to an image which caused the overrun error in the printer, it is highly probable that the overrun error will occur. In an environment where a plurality of printers of the same type being connected together via a network are used, it is not preferable to cause a condition where similar errors occur in respective printers.

### SUMMARY

Accordingly, an advantage of aspects of the invention is that it provides a printer or the like that performs expansion from intermediate code into image data, which is capable of reducing the probability of occurrence of overrun errors to a greater degree than ever before by utilizing a network.

According to a first aspect of the invention, there is provided herein a printer which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, and further includes a storing section configured to store prior expansion related information used for determination of whether the prior expansion process is to be executed, and includes a self-based updating section configured to, on the basis of an event arising in the printer which makes it necessary for the printer to update the prior expansion related information, update the prior expansion related information stored in the storing section, and a reception-based updating section configured to, subsequent to updating of the prior expansion related information in another printer or other printers of the same type as the printer, receive the updated prior expansion related information, and update the prior expansion related information stored in the storing section in accordance with the received prior expansion related information.

Preferably, the printer according to the first aspect of the invention further includes a delivering section configured to, subsequent to updating of the prior expansion related information by the self-based updating section, transmit the updated prior expansion related information to another printer or other printers of the same type as the printer, which are connected to the printer via a network.

Preferably, in the printer according to the first aspect of the invention, the reception-based updating section is configured to receive the updated prior expansion related information from another printer or other printers of the same type as the printer, a host device for the printer and a management server for the printer, which are connected to the printer via a network.

According to a second aspect of the invention there is provided herein a printer system including at least two printers each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, and a management server connected to the at least two printers, wherein each printer of the at least two printers includes a storing section configured to store prior expansion related information used for determination of whether the prior expansion process is to be executed, a self-based updating section configured to, on the basis of an event arising in the printer which makes it necessary for the printer to update the prior expansion related information, update the prior expansion related information stored in the storing section, a first transmitting section configured to, subsequent to updating of the prior expansion related information by the self-based updating section, transmit the updated prior expansion related information to the management server, and a reception-based updating section configured to, subsequent to updating of the prior expansion related information in another printer or other printer of the same type as the printer, receive the updated prior expansion related information, and update the prior expansion related information stored in the storing section in accordance with the received prior expansion related information, and wherein the management server includes a second transmitting section configured to receive the prior expansion related information transmitted from the first transmitting section of the at least two printers, and transmit the received prior expansion related information to another printer or other printers out of the at least two printers, being of the same type as the transmitting printer of the prior expansion related information.

According to a third aspect of the invention, there is provided herein a printer system including at least two printers each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, and a management server connected to the at least two printers, wherein each printer of the at least two printers includes a storing section configured to store prior expansion related information used for determination of whether the prior expansion process is to be executed, a self-based updating section configured to, on the basis of an event arising in the printer which makes it necessary for the printer to update the prior expansion related information, update the prior expansion related information stored in the storing section, a first transmitting section configured to, subsequent to updating of the prior expansion related information by the self-based updating section, transmit the updated prior expansion related information to the management server, and wherein the management server includes a retaining section configured to receive the prior expansion related information transmitted from the first transmitting section of the at least two printers, and retain the received prior expansion related information in a condition where the received prior expansion related information is allowed to be acquired from another device or other devices via the network.

According to a fourth aspect of the invention, there is provided herein a printer management server which is connected to at least two printers via a network, each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, wherein the printer management server is configured to, subsequent to updating of the prior expansion related information in any printer of the at least two printers, receive the updated prior expansion related information transmitted from the printer, and transmit the received prior expansion related information to another printer or other printers out of the at least two printers, being of the same type as the transmitting printer of the updated prior expansion related information.

According to a fifth aspect of the invention, there is provided herein a printer management server which is connected to at least two printers via a network, each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, wherein the printer management server is configured to, subsequent to updating of the prior expansion related information in any printer of the at least two printers, receive the updated prior expansion related information transmitted from the printer, and retain the received prior expansion related information in a condition where the received prior expansion related information is allowed to be acquired from another device or other devices via the network.

Further advantages and characteristics of the invention will be apparent from exemplary embodiments of the invention described below.

### BRIEF DESCRIPTION OF THE DRAWINGS

FIG. 1 is a block diagram illustrating a configuration of an example of a printer according to a first embodiment of the invention.

FIG. 2 is a flowchart illustrating processes of transmitting prior expansion related information, according to a first embodiment of the invention.

FIG. 3 is a diagram illustrating a configuration of an example of a printer system according to a second embodiment of the invention.

FIG. 4 is a diagram illustrating a configuration of modified examples of a printer system according to a second embodiment of the invention.

### DESCRIPTION OF EXEMPLARY EMBODIMENTS

Exemplary embodiments of the invention will be hereinafter described with reference to the accompanying drawings. It is to be noted that the scope of the invention is not limited to the following exemplary embodiments. In addition, in the figures, the same reference numerals or the same reference symbols will be used to illustrate elements which are the same as or similar to corresponding elements.

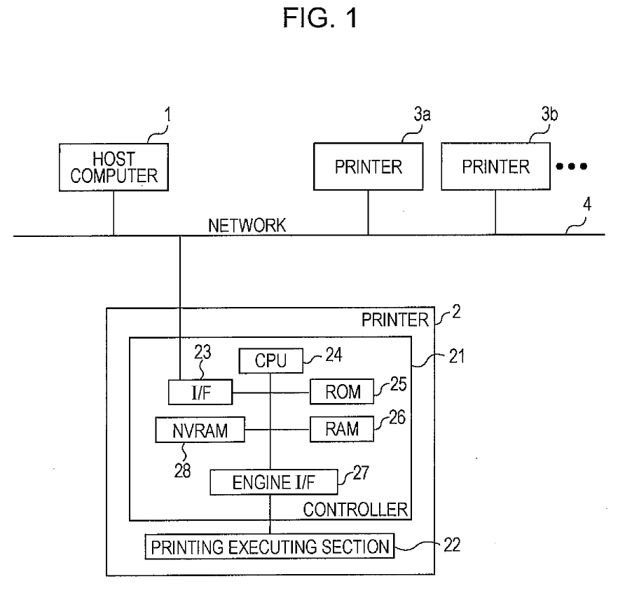

FIG. 1 is a block diagram illustrating a configuration of an example of a printer according to a first embodiment of the invention. A printer 2, shown in FIG. 1, according to the first aspect of the invention has a section for storing prior expansion related information, which is used for determining whether the prior expansion is to be executed, or not, and updates the stored prior expansion related information on the basis of overrun errors occurring during printing processes performed by the printer 2. Furthermore, in order to reduce the probability of occurrence of overrun errors to a greater degree than ever before by utilizing a network, the printer 2 receives updated prior expansion related information which has been transmitted via the network by other printers of the same type as the printer 2 subsequent to occurrence of overrun errors during printing processes performed by the above-described other printers, and updates the stored prior expansion related information.

As shown in FIG. 1, the printer 2 according to the first embodiment of the invention is connected to a host computer 1, and other printers 3a and 3b and the like, via a network 4. The host computer 1 is a host device configured to send a request for printing to the printer, and when sending the request for printing, a printer driver (not shown in FIG. 1) for driving the printer 2, which is included in the host computer 1, generates printing data in a printer description language which can be interpreted by the printer 2 and transfers the generated printing data to the printer 2. Additionally, the host computer 1 can be constituted by a personal computer or the like. Further, the printer driver is constituted by programs and also a controller and the like included in the host computer 1 for executing certain processes in accordance with the programs.

Moreover, the printer 3a is a printer of the same type as the printer 2, and further, is of the same configuration and has the same functions as the printer 2. The printer 3b is of a type different from that of the printer 2.

As shown in FIG. 1, the printer 2 is a printer, such as a laser printer, which is constituted by a controller 21, a printing executing section 22 and the like.

Upon receipt of the printing data transferred from the host computer 1, the controller 21 interprets control content included in the printing data, and further, generates data to be supplied to the printing executing section 22 by performing a predetermined process regarding image data included in the printing data. As shown in FIG. 1, the controller 21 includes an I/F section 23, a CPU 24, a ROM section 25, a RAM section 26, an engine I/F section 27 and an NVRAM section 28.

The I/F section 23 is a section configured to perform processes of communicating with other devices via the network, such as a process of receiving printing data transferred from the host computer 1. The RAM section 26 is a section configured to store various kinds of programs for performing control of the printer 21 and the like.

The RAM section 26 is a section configured to temporarily retain data and the like during processes performed by the controller 21, and store the printing data transferred from the host computer 1, generated intermediate codes and the like.

The NVRAM section 28 is a non-volatile memory section configured to store information to be retained even in a condition where the printer 2 is powered off. In the NVRAM 28, prior expansion related information, which is associated with features of the printer 2, is stored. The prior expansion related information is information which is used for determining whether a prior expansion process, which will be described below, is to be performed, or not, and includes a threshold value with which an evaluation point for each bound is compared, and a coefficient of load corresponding to each kind of intermediate code; wherein the evaluation point for each bound is an evaluation point resulting from evaluating of a load imposed by the expansion process performed on a bound-by-bound basis, that is, an evaluation point resulting from evaluating of an amount of time required for achievement of the expansion process performed on a bound-by-bound basis, and a larger evaluation point represents the fact that a larger amount of time is required to achieve the expansion process. Further, the threshold value is a determination reference value, and regarding a bound, for which the evaluation point is beyond the determination reference value, it is determined that an expansion process is to be performed. Furthermore, the coefficient of load corresponding to each kind of intermediate code represents the degree of load imposed by the expansion process regarding each kind of intermediate code, which represents an image object of a target for drawing. Further, the evaluation point for each bound is obtained by totaling evaluation points for respective intermediate codes included in the bound, which can be obtained by using the coefficients of load. In addition, a bound is one of divided areas resulting from dividing a one-page area in the sub-scanning direction (i.e., in the direction of transport of a sheet of paper).

The CPU 24 is a section configured to perform control of various processes performed in the printer 2, and particularly, perform a process of storing the received printing data in the RAM section 26, a process of interpreting control content included in the printing data and directing the printing executing section 22 to perform appropriate printing processes, and a process of performing control of operation units functioning as interfaces with users. The printer 2 is characterized by a process of updating prior expansion related information performed by the CPU 24, which will be described below. In addition, the processes executed by the CPU 24 are performed mainly in accordance with programs stored in the ROM section 25.

Next, the engine I/F section 27 is a section configured to function as an interface between the controller 21 and the printing executing section 22, and in synchronization with printing operations performed by the printing executing section 22, the engine I/F section 27 reads out the intermediate codes stored in the RAM section 26 at predetermined timings, and supplies the printing executing section 22 with signals resulting from performing predetermined processes regarding the read-out intermediate codes. More specifically, the engine I/F 27 section performs processes in synchronization with operations performed by the printing executing section 22, such as a conversion process, in which the read-out intermediate codes are expanded into image data, a screening process and a pulse-width modulating process, and then, transfers the resultant signals to the printing executing section 22.

Next, the printing executing section 22 is constituted by a charging unit, an exposing unit, a developing unit, a transcribing unit and a photographic fixing unit, which are not shown in FIG. 1. The printing executing section 22 performs printing processes in accordance with printing directions from the CPU 24 on the basis of the signals transferred from the engine I/F section 27, and as a result, an image is generated on a certain printing medium in accordance with a printing request.

The printer 2 according to the first embodiment of the invention, which is constituted by components described above, executes the following processes when performing print operations.

As described above, when a printing request is initiated in the host computer 1, printing data, which is described in a printer description language, such as PDL, is transferred from the host computer 1 to the printer 2, and then, the printing data is stored in the RAM section 26. Subsequently, the CPU 24 generates intermediate code from the printing data. Additionally, subsequent processes will be described focusing on processes of one-page printing.

The intermediate codes are pieces of data to be generated for each bound, representing image objects included in the bound, and being represented by drawing codes so that generation of image data to be subsequently generated can be made easier.

The CPU 24 generates the intermediate codes of one page and retains the intermediate codes in a predetermined portion of the RAM section 26. Subsequently, for each bound, the CPU 24 performs the evaluation for prior expansion regarding the generated intermediate codes. More specifically, for respective intermediate codes included in a bound, the CPU 24 obtains evaluation points each representing a load of prior expansion, by using the above-described coefficients of load corresponding to respective kinds of intermediate codes, which are stored in the NVRAM section 28 as a piece of the prior expansion related information, and then, regards an evaluation point resulting from totalizing evaluation points for respective intermediate codes as an evaluation point for the bound.

Subsequently, the CPU 24 compares the obtained evaluation points for respective bounds with the above-described threshold value which is also stored in the NVRAM section 28 as a piece of prior expansion related information, and determines bounds having evaluation points greater than the threshold value to be bounds for each of which the expansion process of converting intermediate codes into image data supplied to respective pixels will not be able to be completed in time for operations performed by the printing executing section 22, and then, performs the prior expansion processes regarding the bounds. More specifically, the CPU 24 performs processes of expanding intermediate codes in the bounds into image data as of this moment, stores the expanded image data in a certain portion of the RAM section 26, and then, incorporates a stored portion address in the intermediate codes as a piece of pointer information.

Subsequent to completion of the processes described above, under a condition where the intermediate codes of one page are retained in the RAM section 26, once the processes regarding the page are commenced by the printing executing section 22, the retained intermediate codes are read out on a bound-by-bound basis, and the above-described respective processes to be executed by the engine I/F section 27 are performed in synchronization with operations performed by the printing executing section 22. More specifically, as described above, the engine I/F section 27 performs processes such as a conversion process of expanding the read-out intermediate codes into image data, a screening process and a pulse-width modulating process, and then, transfers the resultant signals to the printing executing section 22. These processes are sequentially performed on a bound-by-bound basis. Additionally, as described above, with respect to each of bounds for which the prior expansion processes have already been completed, the expansion process terminates subsequent to reading out image data which has already been generated.

The printing executing section 22 performs printing operations on a printing medium in accordance with the transferred signals, and subsequently, the processes on the page are completed.

Additionally, since the above-described determination as to whether the prior expansion is to be performed, or not, is not performed with a high degree of accuracy, regarding bounds which are determined not to be targeted for the prior expansion, a condition, in which the above-described expansion processes are not able to be completed in time for printing operations, possibly arises. Once such a condition arises during printing operations on a certain page of a printing medium, subsequent to completion of printing operations regarding only bounds for which the expansion processes have been completed, the printing medium is ejected, and then, the occurrence of an overrun error is notified to users.

Further, the CPU 24 changes certain pieces of the prior expansion related information so that the prior expansion process is to be performed regarding the bounds which caused the overrun error, as well as, the degree of accuracy in determination as to whether the prior expansion is to be performed, or not, can be improved. More specifically, the CPU 24 makes changes in accordance with the same methods as or methods similar to existing methods, such as a method of lowering the threshold value on the basis of evaluation points for bounds which caused the overrun errors, a method of increasing certain coefficients of load corresponding to kinds of intermediate codes included in the bounds which caused the overrun errors, or the like. Further, the CPU 24 updates the prior expansion related information stored in the NVRAM section 28 in accordance with the changed prior expansion related information.

Subsequently, even if a printing request for printing of the page which caused the overrun error is received again, the probability of occurrence of overrun error at this time becomes lower than at a previous time, that is, the probability of successful completion of the requested printing of the page at this time becomes higher than at a previous time.

Furthermore, regarding the following printing requests (printing jobs), the improved degree of accuracy in determining whether the prior expansion is to be performed, or not, enables realization of printing operations capable of reducing the probability of occurrence of overrun errors to a greater degree than before the prior expansion related information was updated.

The printer 2 is characterized by the processes performed subsequent to the above-described process of updating the prior expansion related information, and the processes will be hereinafter described.

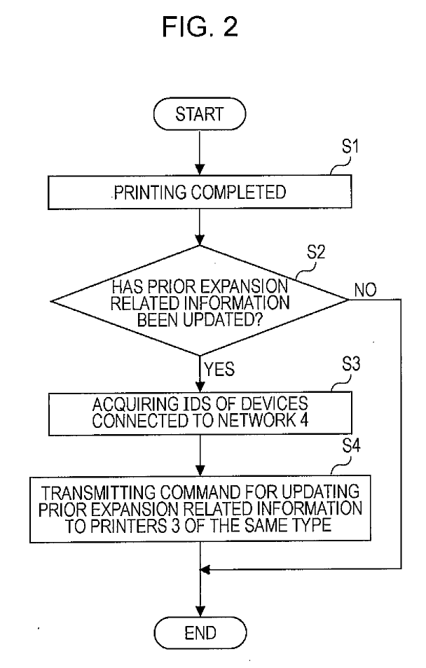

FIG. 2 is a flowchart illustrating processes of transmitting prior expansion related information, according to the first embodiment of the invention. In step S1, the CPU 24 completes printing processes in response to a received request for a printing job, and then, in step S2, the CPU 24 determines whether the prior expansion related information has been updated, or not, throughout the printing processes. As a result, when the determination in step S2 is “No”, i.e., in the case where the prior expansion related information has not been updated, the flow terminates.

On the other hand, when the determination in step S2 is “Yes”, i.e., in the case where the prior expansion related information has been updated, the CPU 24 transmits the updated prior expansion related information to every printer 3 of the same type as the printer 2, which is connected to the network 4. Specifically, first, in step S3, the CPU 24 requests all devices connected to the network 4 to send back their own device IDs in order to acquire their own device IDs. Further, from among the acquired device IDs, the CPU 24 identifies printers 3 of the same type as the printer 2, and then, in step S4, transmits the updated prior expansion related information to the printers 3, i.e., to the printer 3a and the like in the example shown in FIG. 1. More specifically, the CPU 24 transmits a change request command for changing prior expansion related information, which is described in a printer control language or the like, and thereby, requests the printers 3 to change prior expansion related information retained thereby in accordance with the prior expansion related information updated by the printer 2.

At the same time as completion of the processes described above, the flow at the printer 2 side terminates, and subsequently, each of the printer 3a and the like, to which the change request command for changing the prior expansion related information has been transmitted by the printer 2, interprets the received command, and then, in accordance with directions included in the command, updates the prior expansion related information retained thereby on the basis of the prior expansion related information updated by the printer 2.

Further, each of the printers 3 of the same type as the printer 2, which are the printer 3a and the like shown in FIG. 1, has functions the same as or similar to those of the printer 2, and thus, upon acknowledgement of the occurrence of overrun errors, in the same way as or in a way similar to that performed by the printer 2, the printer 3 of the same type as the printer 2 updates prior expansion related information retained thereby, and then, performs processes of transmitting the updated prior expansion related information to other printers of types the same as that of the printer 3. In this case, since a change request command for changing prior expansion related information is also transmitted to the printer 2, upon receipt of the command, the CPU 24 of the printer 2 updates the prior expansion related information stored in the NVRAM section 28 in accordance with the received command. Subsequent to completion of the update, as a result, the printer 2 determines whether the prior expansion is to be performed, or not, in the accordance with the prior expansion related information which was improved by the printer 3 of the same type as the printer 2 on the basis of overrun errors which occurred in the printer 3.

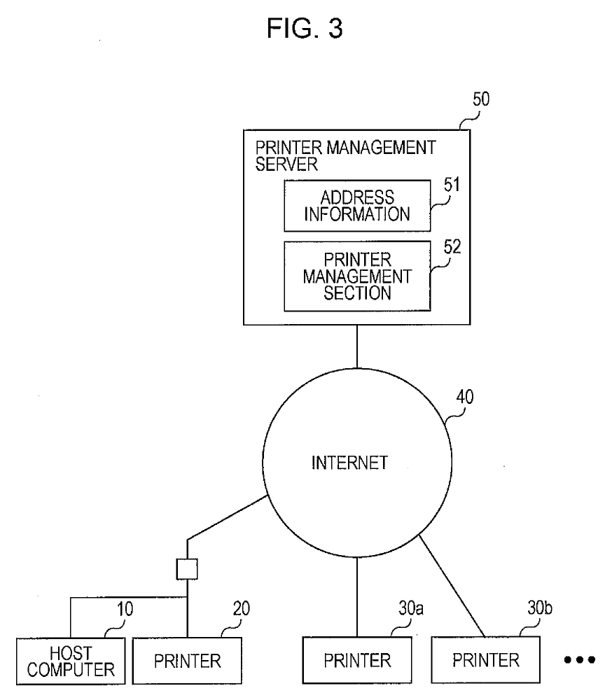

Next, a second embodiment will be hereinafter described. FIG. 3 is a diagram illustrating a configuration of an example of a printer system according to the second embodiment of the invention. In FIG. 3, a printer management server 50 and a plurality of printers (20, 30a, 30b, . . . ) connected to the server 50 via internet 40 constitute a printer system according to aspects of the invention. In the printer system, once the above-described prior expansion related information is updated by a printer, the printer reports the updated prior expansion related information to the printer management server 50, and the printer management server 50 transmits the updated prior expansion related information to other printers of the same type as the transmitter, i.e., the printer which has transmitted the updated prior expansion related information, so that the prior expansion related information improved by one printer is reflected to prior expansion related information retained by other printers of the same type as the printer.

A printer 20 shown in FIG. 3 is a printer of the same configuration and having the same functions as the printer 2 in the first embodiment; however, in operations performed by the printer 20, there are two differences from operations performed by the printer 2 in the first embodiment, one being a receiving device to which a certain printer transmits prior expansion related information updated thereby on the basis of overrun errors which occurred in the certain printer, the other one being a transmitting device from which a certain printer receives prior expansion related information updated by one of other printers of the same type as the certain printer. The receiving device, as well as, the transmitting device, is the printer management server 50 in the second embodiment.

Further, the host computer 10 is a host device for the printer 20, having the same functions as the host computer 1 in the first embodiment.

The printer 30a is a printer of the same type as the printer 20, having a configuration and functions the same as or similar to those of the printer 20. The printer 30b is a printer of a type different from that of the printer 20, having a configuration and functions the same as or similar to those of the printer 20.

The printer management server 50 is a server configured to manage the above-described printers connected thereto via the internet 40, and is managed by a printer manufacturer or the like. As shown in FIG. 3, the printer management server 50 includes a block of address information 51 and a printer management section 52. The block of address information is a block of information including device IDs and IP addresses and the like corresponding to respective printers connected to the internet 40. Further the printer management section 52 is a section configured to receive prior expansion related information transmitted from respective printers and transmit the prior expansion related information to printers other than the transmitting printer. Further, the printer management server 50 is constituted by a personal computer or the like. Therefore, the printer management server 50 includes various kinds of hardware such as a CPU, RAM chips, ROM chips and a hard disc, and the block of address information is stored in the hard disc, and further, the printer management section 52 can be constituted by programs stored in ROM chips and also a CPU executing processes in accordance with the programs,

As described above, the printer system is characterized by processes of delivering updated prior expansion related information, and the processes will be hereinafter described.

The description will be made by way of an example in which an overrun error occurs in the printer 20. Once an overrun error occurs, as described in the first embodiment, the printer 20 updates prior expansion related information retained thereby. Subsequently, at a predetermined timing such as a timing when printing processes based on a received printing request has been completed, the printer 20 transmits the updated prior expansion related information to the printer management server 50. In addition, when transmitting the prior expansion related information, the printer 20 adds a device ID thereof (i.e., a device ID of the printer 20) to the prior expansion related information.

Subsequent to completion of the transmission described above, in the printer management server 50, the printer management section 52 receives and retains the prior expansion related information transmitted by the printer 20. Next, the printer management section 52 accesses the block of address information, and thereby, obtains IP addresses of printers each having the same device ID as the device ID being added to the received prior expansion related information. Subsequently, by using a printer control language or the like, the printer management section 52 generates a change request command for requesting receivers to change prior expansion related information retained thereby in accordance with received prior expansion related information, and transmits the command to printers each having one of the IP addresses obtained above. That is, the printer management section 52 transmits the command to other printers of the same type as the printer 20 which is a transmitter of the updated prior expansion related information. In the example shown in FIG. 3, the command is transmitted to the printer 30a and the like.

Each printer to which the command is transmitted interprets the received command, and updates prior expansion related information retained thereby in accordance with a direction included in the received command. That is to say, as a result, the prior expansion related information updated by the printer 20 is retained by other printers of the same type as the printer 20, which are connected to the printer 20 via the internet 40. Therefore, as a result, in subsequent operations performed by a certain printer, printing processes are performed in accordance with prior expansion related information improved by other printers of the same type as the certain printer on the basis of overrun errors which occurred in the above-described other printers.

Additionally, in the case where a transmitter of the updated prior expansion related information is not the printer 20 but a printer of the same type as the printer 20, (for example, the printer 30a), the same processes as or processes similar to those described above are performed, and upon receipt of a change request command described above from the printer management server 50, the printer 20 updates prior expansion related information retained thereby.

Next, modified examples of the second embodiment will be hereinafter described. In a first modified example, by the printer management server, prior expansion related information reported from a certain printer is not directly transmitted to other printers but is incorporated into each printer driver stored in the printer management server, and further, is disclosed so as to be acquirable from other printers.

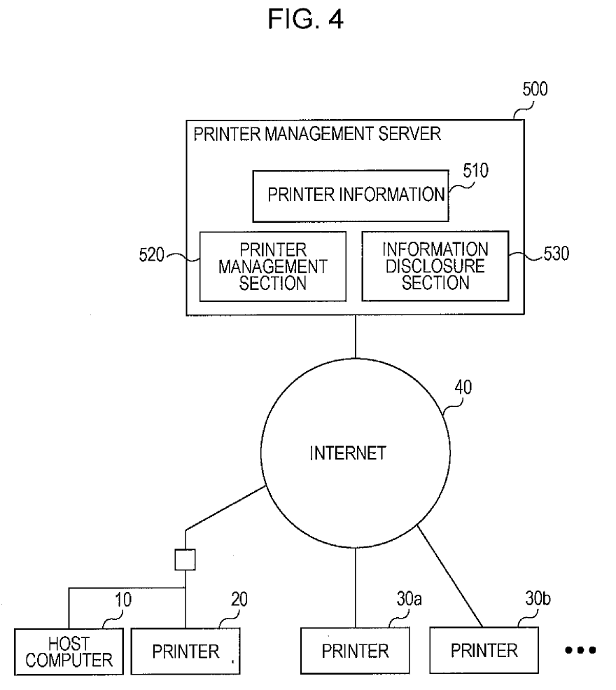

FIG. 4 is a diagram illustrating a configuration of the first modified example of a printer system according to the second embodiment. A portion constituted by the host computer 10 and the printers (20, 30a, 30b, . . . ) in this first modified example is the same as or similar to that in the foregoing example of the second embodiment. As shown in FIG. 4, the printer management server 500 includes a block of printer information 510, a printer management section 520 and an information disclosure section 530, and is managed by a printer manufacturer or the like.

In addition, the printer management server 500 is constituted by a personal computer or the like, and therefore, includes various kinds of hardware such as a CPU, RAM chips, ROM chips and a hard disc. The block of printer information 510 is a block of information configured to include device IDs of respective printers and the corresponding driver programs and the like, and is stored in the hard disc.

The printer management section 520 is a section configured to incorporate prior expansion related information reported by respective printers in driver programs, and store the driver programs in the hard disc as pieces of the printer information 510 described above. Further, the information disclosure section 530 is a section configured to disclose the block of printing information 510 via the internet 40. In addition, the printer management section 520 and the information disclosure section 530 can be constituted by certain components such as programs stored in the ROM chips, a CPU executing processes in accordance with the programs, respectively.

In the printer system of the first modified example, in the same manner as or in a manner similar to that of the example in the second embodiment, for example, subsequent to occurrence of an overrun error, the printer 20 updates prior expansion related information retained thereby, and further, transmits the updated prior expansion related information to the printer management server 50. In addition, when transmitting the updated prior expansion related information, the printer 20 adds a device address thereof (i.e., a device address of the printer 20) to the updated prior expansion related information.

Subsequently, upon receipt of the updated prior expansion related information, the printer management section 520 updates a piece of prior expansion related information in accordance with the received prior expansion related information, wherein the piece of prior expansion related information is incorporated in a driver program which corresponds to a received device ID and is stored in the block of printer information 510. Additionally, each of the driver programs incorporating the prior expansion related information therein is generated in advance so that, when the driver program is installed into the host computer, the driver program directs a target printer to update prior expansion related information retained by the printer in accordance with the prior expansion related information incorporated in the driver program.

By utilizing a so-called home page or the like, the information disclosure section 530 provides users who are able to access a site of the information disclosure section 530 with a notice in which printer drivers corresponding to printers of respective types can be acquired (i.e. can be downloaded) via the internet 40, and, for example, in FIG. 4, upon receipt of an acquisition request for acquiring a driver program used for the printer 20, which is made by the host computer 10 through an access to the site of the disclosure section 530, the information disclosure section 530 transmits the updated driver program to the host computer 10. In addition, the information disclosure section 530 specifies a device ID from the acquisition request, and transmits a driver program corresponding to the specified device ID, which has been stored in the block of information 510. With respect to printers of other types, driver programs can be also downloaded in the same manner as or in a manner similar to that described above.

Once the driver program is downloaded in accordance with the above-described processes, as described above, the driver program issues a change request command to a printer, and upon receipt of the command, the printer updates prior expansion related information retained thereby.

Next, a second modified example of the second embodiment will be hereinafter described. Configuration and processes in the second modified example are the same as or similar to those in the first modified example, except for a method for disclosing prior expansion related information. In the second modified example, pieces of prior expansion related information transmitted from respective printers are not incorporated in the corresponding driver programs, but are stored in the corresponding files each including only the piece of prior expansion related information and the files are stored in the block of printer information 510 by the printer management section 520, and further, the files are disclosed by the information disclosure section 530. In the same manner as or in a manner similar to that in the first modified example, once a user, who is allowed to access the information disclosure section 530, makes a request for acquisition of the file to the information disclosure section 530, the information disclosure section 530 transmits the requested file to the requesting user (i.e., the host computer 10 or the like).

Upon receipt of the file, the user directly transfers the file from a host computer to a printer, or alternatively, stores the file into a removal memory or the like, and from the removal memory or the like attached to the printer, transfers the file to the printer, and then, causes the printer to update prior expansion related information retained thereby on the basis of content of the transferred file.

As described above, in the first modified example and the second modified example, the printer management server 500 retains the most latest prior expansion related information in a condition that allows other devices to acquire the above-described information via the internet 40. Further, the printer management server 500 may be constituted by a plurality of separate devices, and, for example, respective sections included in the printer management server 500, which are the block of printer information 510, the information management section 520 and the information disclosure section 530, may be separated from the printer management server 500.

As described above, a printer in the examples and modified examples according to the embodiments of the invention updates prior expansion related information on the basis of processes performed by the printer such as a process performed in the case where an overrun error occurs therein, and further, in the case where updated prior expansion related information is updated in other printers each being of the same type as the printer, upon receipt of the updated information, the printer updates prior expansion related information retained thereby in accordance with the updated information. Accordingly, without depending on experiences of only the overrun errors occurring in the printer, the printer is capable of utilizing prior expansion related information improved by other printers on the basis of experiences of overrun errors occurring in the above-described other printers, and thus, the utilization of improved prior expansion related information transmitted from other printers enables the printer to reduce the probability of occurrence of overrun errors to a greater degree than ever before.

Furthermore, in the examples of the first and second embodiments, the prior expansion related information is automatically updated, and thus, no users, manual operation leads to enhancement of convenience.

In contrast, in the first and second modified examples of the second embodiment, the most latest prior expansion related information updated by other printers is disclosed, and therefore, at any appropriate time, users can update prior expansion related information stored in the printer on the basis of the most latest prior expansion related information in accordance with the users, determination. In usual cases, updating of the prior expansion related information for the purpose of reducing the probability of occurrence of overrun errors leads to increasing of the amount of prior expansion, and therefore, in such a case, a user who prioritizes a throughput of a printer thereof can select not to perform updating of the prior expansion related information in accordance with the most latest prior expansion related information.

In addition, in the examples and modified examples of the second embodiment, respective printers are connected to a printer management server via the internet, however, alternatively, respective printers may be connected to a printer management server via a network other than the internet.

The protection scope of the invention is not limited to the above-described embodiments but extends to the breadth of the appended claims and any equivalents thereof.

The entire disclosure of Japanese Patent Application No. 2008-80337, filed Mar. 26, 2008 is expressly incorporated by reference herein.

What is claimed is:

1. A printer configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, the printer comprising:
a storing section configured to store prior expansion related information used for determination of whether the prior expansion process is to be executed;
a self-based updating section configured to, on the basis of an event arising in the printer which makes it necessary for the printer to update the prior expansion related information, update the prior expansion related information stored in the storing section; and
a reception-based updating section configured to, subsequent to updating of the prior expansion related information in another printer or other printers of the same type as the printer, receive the updated prior expansion related information, and update the prior expansion related information stored in the storing section in accordance with the received prior expansion related information.

2. The printer according to claim 1, further comprising:
a delivering section configured to, subsequent to updating of the prior expansion related information by the self-based updating section, transmit the updated prior expansion related information to another printer or other printers of the same type as the printer, that are connected to the printer via a network.

3. The printer according to claim 1, wherein the reception-based updating section is configured to receive the updated prior expansion related information from another printer or other printers of the same type as the printer, a host device for the printer and a management server for the printer, which are connected to the printer via a network.

4. A printer system, comprising:
at least two printers each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process; and
a management server connected to the at least two printers, wherein each printer of the at least two printers includes, a storing section configured to store prior expansion related information used for determination of whether the prior expansion process is to be executed,
a self-based updating section configured to, on the basis of an event arising in the printer which makes it necessary for the printer to update the prior expansion related information, update the prior expansion related information stored in the storing section,
a first transmitting section configured to, subsequent to updating of the prior expansion related information by the self-based updating section, transmit the updated prior expansion related information to the management server, and
a reception-based updating section configured to, subsequent to updating of the prior expansion related information in another printer or other printer of the same type as the printer, receive the updated prior expansion related information, and update the prior expansion related information stored in the storing section in accordance with the received prior expansion related information, and
wherein the management server includes a second transmitting section configured to receive the prior expansion related information transmitted from the first transmitting section of the at least two printers, and transmit the received prior expansion related information to another printer or other printers out of the at least two printers, being of the same type as a transmitting printer of the prior expansion related information.

5. A printer system according to claim 4,
wherein the management server further includes a retaining section configured to receive the prior expansion related information transmitted from the first transmitting section of the at least two printers, and retain the received prior expansion related information in a condition where the received prior expansion related information is allowed to be acquired from another device or other devices via the network.

6. A printer management server which is connected to at least two printers via a network, each of which is configured to convert printing data into an intermediate code in advance, perform an expansion process of converting the intermediate code into image data in synchronization with operations performed by a printing executing section, make a determination for each prescribed bound as to whether a prior expansion process, in which the expansion process is performed prior to commencement of the operations performed by the printing executing section, is to be executed, or not, and execute the prior expansion process regarding a prescribed bound which has been determined to be a bound which requires execution of the prior expansion process, wherein the printer management server is configured to, subsequent to updating of the prior expansion related information in any printer of the at least two printers, receive the updated prior expansion related information transmitted from the printer, and transmit the received prior expansion related information to another printer or other printers out of the at least two printers, being of the same type as the transmitting printer of the updated prior expansion related information.

7. A printer management server according to claim 6, wherein the printer management server is further configured to retain the received prior expansion related information in a condition where the received prior expansion related information is allowed to be acquired from another device or other devices via the network.
